(19) United States
(12) Patent Application Publication
(10) Pub. No.: US 2015/0016041 A1
(43) Pub. Date: Jan. 15, 2015

(54) ELECTRONIC APPARATUS AND MODULE

(71) Applicant: KABUSHIKI KAISHA TOSHIBA, Tokyo (JP)

(72) Inventor: Kiyomi Muro, Hachioji-shi (JP)

(21) Appl. No.: 13/938,649

(22) Filed: Jul. 10, 2013

(51) Int. Cl. G06F 1/16

(52) U.S. Cl. CPC G06F 1/1683
USPC 361/679.28; 361/679.55

(57) ABSTRACT

According to one embodiment, an electronic device includes a first attachment part; a second attachment part separated from the first attachment part; a flexible printed circuit board including a first connection part fixed to the first attachment part, a second connection part fixed to the second attachment part, a coupling part to couple the first connection part and the second connection part and provided with a slit extending in a first direction connecting the first connection part and the second connection part, and a bending part provided in the coupling part; and a bonding sheet provided on one side of the second connection part for bonding the second connection part and the first attachment part away from the coupling part in a second direction along a direction in which the second connection part extends, and to bond the second connection part and the first connection part inside the slit.

### FIELD

Embodiments described herein relate generally to an electronic device having a flexible printed circuit board.

### BACKGROUND

A flexible printed circuit board with slits is disclosed. The flexible printed circuit board is widely used in electronic devices, and various electronic components are mounted on the flexible printed circuit board. The flexible printed circuit board can be used in various applications, and there is a need to improve the flexible printed circuit board.

An object to be achieved by the present invention is to provide an electronic device with an improved flexible printed circuit board.

### BRIEF DESCRIPTION OF THE DRAWINGS

FIG. 1 is an exemplary perspective view illustrating a portable computer as an exemplary electronic device according to a first embodiment;

FIG. 2 is an exemplary plan view illustrating a folded module housed in the portable computer illustrated in FIG. 1;

FIG. 3 is an exemplary cross-section view along line F3-F3 in FIG. 2;

FIG. 4 is an exemplary cross-section view along line F4-F4 in FIG. 2;

FIG. 5 is an exemplary cross-section view along line F5-F5 in FIG. 2;

FIG. 6 is an exemplary plan view illustrating the developed module illustrated in FIG. 2;

FIG. 7 is an exemplary cross-section view along line F7-F7 in FIG. 6;

FIG. 8 is an exemplary plan view illustrating a folded module in a portable computer according to a second embodiment;

FIG. 9 is an exemplary plan view illustrating the developed module illustrated in FIG. 8;

FIG. 10 is an exemplary diagram illustrating enlarged F10 illustrated in FIG. 8;

FIG. 11 is an exemplary plan view illustrating a first variant and a second variant of the module in the portable computer according to the second embodiment;

FIG. 12 is an exemplary plan view illustrating a developed module in a portable computer according to a third embodiment;

FIG. 13 is an exemplary plan view illustrating a third variant of the module in the portable computer according to the third embodiment; and

FIG. 14 is an exemplary plan view illustrating a developed module in a portable computer according to a fourth embodiment.

### DETAILED DESCRIPTION

Various embodiments will be described hereinafter with reference to the accompanying drawings.

In general, according to one embodiment, an electronic device comprises a first attachment part, a second attachment part provided by separation from the first attachment part, a flexible printed circuit board having a first connection part fixed to the first attachment part, a second connection part fixed to the second attachment part, a coupling part configured to couple the first connection part and the second connection part and provided with a slit extending in a first direction connecting the first connection part and the second connection part, and a bending part provided in the middle of the coupling part, and a bonding sheet provided on one side of the second connection part and configured to bond the second connection part and the first attachment part away from the coupling part in a second direction along a direction in which the second connection part extends and to bond the second connection part and the first connection part inside the slit.

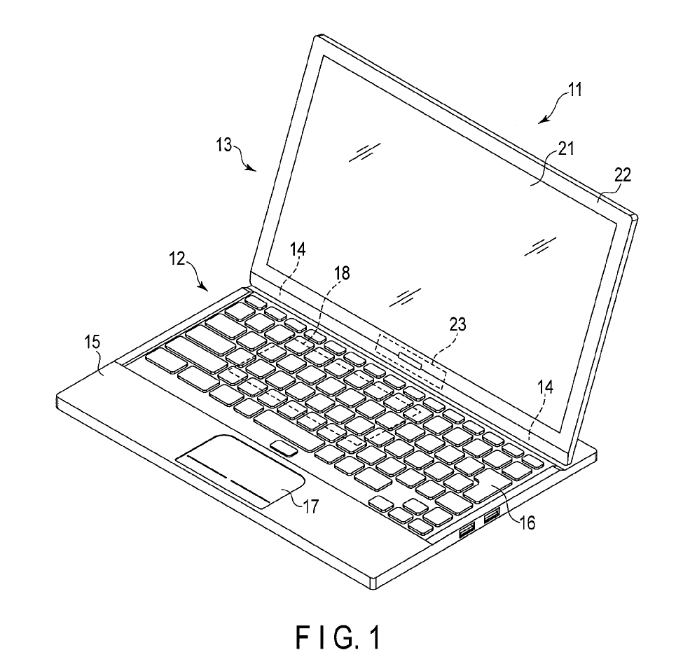

An embodiment of the electronic device will be described below with reference to FIGS. 1 to 7. The present embodiment will be described with a case in which the electronic device is applied to a portable computer by way of example.

As illustrated in FIG. 1, a portable computer 11 comprises a main body part 12, a display part 13, and a hinge part 14 provided between the main body part 12 and the display part 13. The hinge part 14 rotatably supports the display part 13 relative to the main body part 12.

The main body part 12 comprises a box-shaped case 15 made of a synthetic resin material, for example, a keyboard 16 provided on the upper surface (top wall) of the case 15, a touchpad 17 provided on the upper surface of the case 15, and a printed circuit board 18 (motherboard or main board) housed inside the case 15.

The display part 13 comprises a display panel 21, a casing 22 (display case) surrounding the display panel 21, and a module 23 housed inside the casing 22 (inside the frame of the casing 22 or in the frame of the casing 22). The casing 22 is made of a synthetic resin material, for example. The display panel 21 is configured by a liquid crystal display panel according to the present embodiment, but may be other type of display panel such as plasma display panel, organic electroluminescent, plastic display panel or sheet display panel.

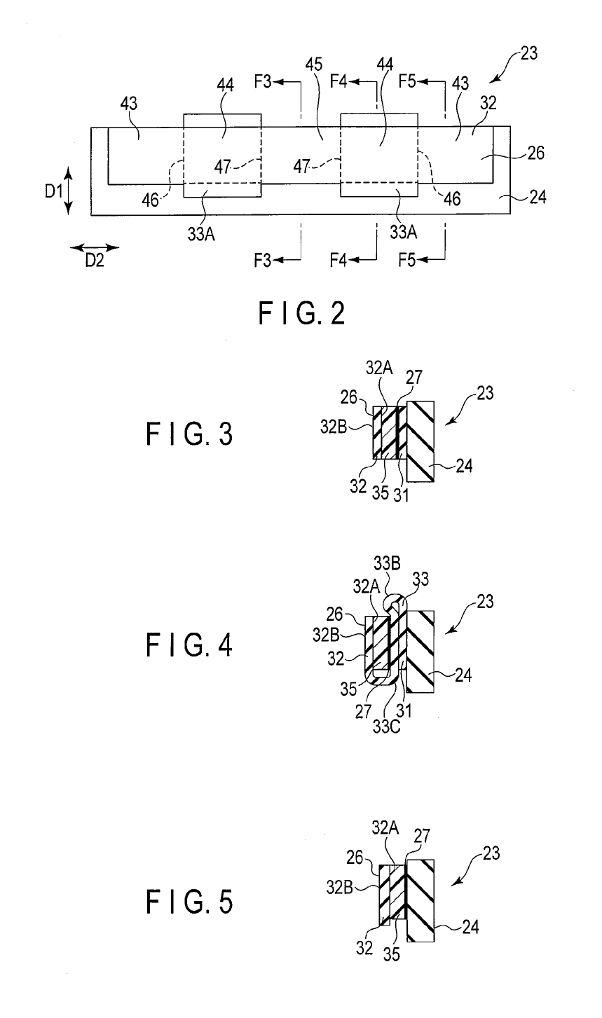

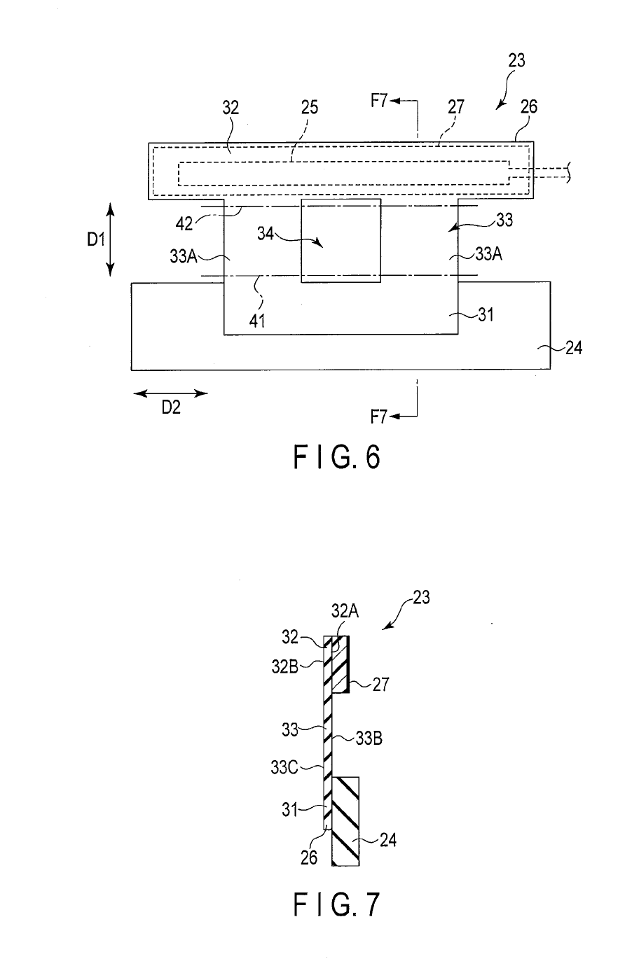

As illustrated in FIG. 2, FIG. 6 and FIG. 7, the module 23 comprises a first attachment part 24 fixed to the display panel 21, for example, a second attachment part 25 connected to the printed circuit board 18 on the main body part 12 side, a flexible printed circuit board 26 connecting the first attachment part 24 and the second attachment part 25, and a bonding sheet 27 provided on one side 32A of a second connection part 32 described later of the flexible printed circuit board 26. The first attachment part 24 is a so-called drive circuit for the display panel 21, and is housed inside the casing 22 together with the display panel 21. The second attachment part 25 is configured by traces or the like connected to the printed circuit board 18 of the main body part 12, and is arranged over both the main body part 12 and the display part 13, for example. The second attachment part 25 is provided by separation from the first attachment part 24. As illustrated in FIG. 3, FIG. 4 and FIG. 5, the module 23 comprises a reinforcing plate 35 bonded to the second connection part 32 via a thermosetting adhesive, for example. The reinforcing plate 35 is formed in a plate shape by a synthetic resin material, for example, and is present between the side 32A of the second connection part 32 and the bonding sheet 27.

The flexible printed circuit board 26 is formed in a thin plate shape with a typical material. As illustrated in FIG. 6, the flexible printed circuit board 26 comprises a first connection part 31 fixed to the first attachment part 24, the second connection part 32 fixed to the second attachment part 25, a coupling part 33 configured to couple the first connection part 31 and the second connection part 32 and extending in a first direction D1 connecting the first connection part 31 and the second connection part 32, and a plurality of bending parts provided in the middle of the coupling part 33.

The first connection part 31 is formed in a belt shape and linearly extends with a predetermined width. The first connection part 31 is fixed to the first attachment part 24 by anisotropic conductive film (ACF), for example. The first connection part 31 may be fixed thereto by soldering, anisotropic conductive paste (ACP), or the like.

The second connection part 32 is formed in a belt shape and linearly extends with a predetermined width. The second connection part 32 extends substantially in parallel with a direction in which the first connection part 31 extends. The second connection part 32 is formed to be longer than the first connection part 31 in a second direction D2 along the direction in which the first connection part 31 and the second connection part 32 extend. The second connection part 32 is fixed to the second attachment part 25 by ACF, for example, but may be fixed thereto by soldering, ACP or the like similarly to the first connection part 31. As illustrated in FIG. 7, the second connection part 32 has one side 32A and the other side 32B opposite to the side 32A.

As illustrated in FIG. 6, the coupling part 33 extends in the first direction D1 connecting the first connection part 31 and the second connection part 32. The first direction D1 is cross with (or orthogonal to) the second direction D2. The coupling part 33 comprises two separated parts 33A, and the two parts 33A configure a coupling part 33. A plurality of metal traces extending in the first direction D1, for example, is arranged at high density in each part 33A of the coupling part 33.

A slit 34 extending in the first direction D1 is provided between the two parts 33A of the coupling part 33. The slit 34 is provided in a substantially square shape, and separates the two parts 33A of the coupling part 33. Two bending parts (a first bending part 41 and a second bending part 42) are provided in the middle of each part 33A of the coupling part 33. The first bending part 41 provided near the first connection part 31 is bent in a valley shape, for example, as viewed from the other side 32A of the second connection part 32. The second bending part 42 provided near the second connection part 32 is bent in a mountain shape, for example, as viewed from the other side 32B of the second connection part 32. Thus, as illustrated in FIG. 4 and others, the flexible printed circuit board 26 is bent substantially in a “Z” shape.

The bonding sheet 27 is bonded on the side 32A of the second connection part 32. The bonding sheet 27 is made of an acrylic adhesive (acrylic pressure-sensitive adhesive), for example, but may be made of a silicon-based adhesive (silicon-based pressure-sensitive adhesive) or rubber-based adhesive (rubber-based pressure-sensitive adhesive).

As illustrated in FIG. 2, the folded module 23 comprises a first region 43, a second region 44 adjacent to the first region 43, a third region 45 adjacent to the second region 44, a first boundary part 46 between the first region 43 and the second region 44, and a second boundary part 47 between the second region 44 and the third region 45. The first region 43 is present outward from the coupling part 33 in the second direction D2. In the first region 43, the bonding sheet 27 bonds the first attachment part 24 and the second connection part 32 (the reinforcing plate 35 bonded to the second connection part 32) (FIG. 5).

As illustrated in FIG. 2 and FIG. 4, in the second region 44, the bonding sheet 27 overlaps on the coupling part 33. In the second region 44, the bonding sheet 27 bonds the second connection part 32 (the reinforcing plate 35 bonded to the second connection part 32) and a first side 33B of the coupling part 33. However, a second side 33C opposite to the first side 33B of the coupling part 33 is not bonded to the first connection part 31. Thus, in the second region 44, the folded flexible printed circuit board 26 generates a repulsive force (a restoring force for returning to the origin).

As illustrated in FIG. 2 and FIG. 3, the third region 45 corresponds to a position inside the slit 34. In the third region 45, the bonding sheet 27 bonds the first connection part 31 and the second connection part 32 (the reinforcing plate 35 bonded to the second connection part 32) inside the slit 34.

The operations of the folded module 23 according to the present embodiment will be described herein. Assuming a total repulsive force of the flexible printed circuit board 26 as W, a width of the bonding sheet 27 in the first direction D1 as A, an anti-release strength of the bonding sheet 27 as B, the number of parts 33A contained in the coupling part 33 as n, and the number of bonding boundary parts between the flexible printed circuit board 26 and the bonding sheet 27 as 2n, the relationship B>(W/2n)/A is met for the module 23 according to the present embodiment. That is, in the present embodiment, the coupling part 33 is provided with the slit 34, and thus the module 23 is formed with the third region 45 in correspondence to the slit 34 in addition to the first region 43 and the second region 44. Thereby, the total repulsive force W (the releasing force for the bonding sheet 27) acting in the release direction (the thickness direction of the bonding sheet 27) acts on not only the bonding sheet 27 along the first boundary part 46 but also the bonding sheet 27 along the second boundary part 47. Thus, the repulsive force W acting on the bonding sheet 27 is dispersed in four portions, thereby preventing the bonding sheet 27 from releasing.

According to the first embodiment, the electronic device comprises the first attachment part 24, the second attachment part 25 provided by separation from the first attachment part 24, the flexible printed circuit board 26 having the first connection part 31 fixed to the first attachment part 24, the second connection part 32 fixed to the second attachment part 25, the coupling part 33 configured to couple the first connection part 31 and the second connection part 32 and provided with the slit 34 extending in the first direction D1 connecting the first connection part 31 and the second connection part 32, and the bending part provided in the middle of the coupling part 33, and the bonding sheet 27 provided on the side 32A of the second connection part 32 and configured to bond the second connection part 32 and the first attachment part 24 away from the coupling part 33 in the second direction D2 along the direction in which the second connection part 32 extends and to bond the second connection part 32 and the first connection part 31 inside the slit 34.

With the structure, the repulsive force of the flexible printed circuit board 26 can be dispersed and received in the two portions including one portion of the bonding sheet 27 away from the coupling part 33 in the second direction D2 and the other portion of the bonding sheet 27 inside the slit 34. Thereby, the repulsive force of the flexible printed circuit board 26 does not focus on one portion, and the bonding sheet 27 is prevented from releasing.

Thus, a certain length of the flexible printed circuit board 26 can be secured on assembly of the product in consideration of workability. On completion of the product, the flexible printed circuit board 26 can be folded along the bending part and can be compactly housed in the casing 22 while being kept in the folded shape by the bonding sheet 27. Thereby, it can contribute to recently remarkable reduction in size and thickness of electronic devices. A structure of pushing the flexible printed circuit board 26 toward the casing 22 does not need to be provided, thereby simplifying the structure of the casing.

### Second Embodiment

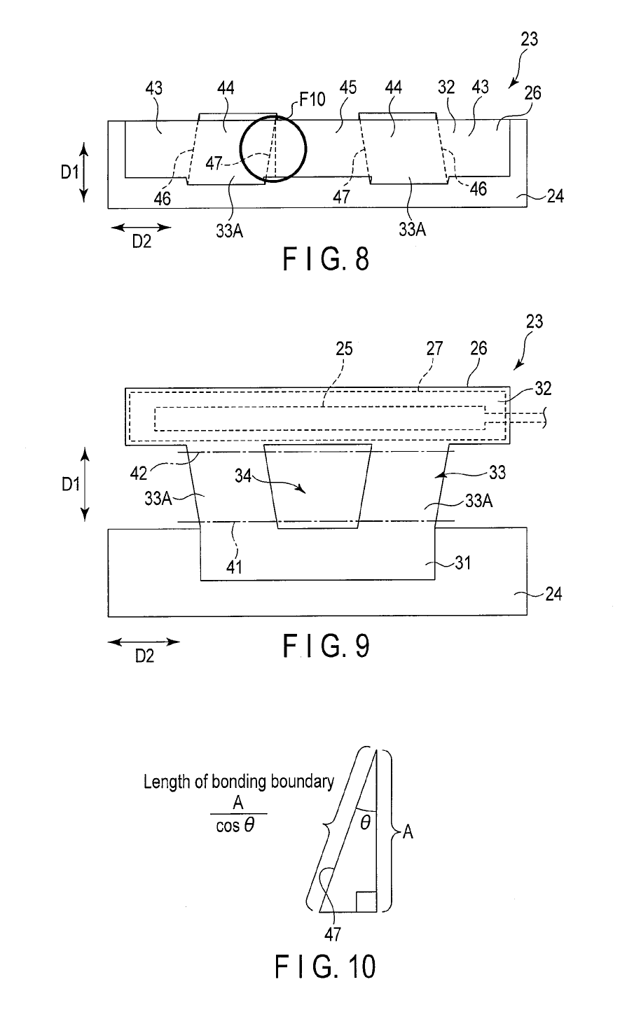

Subsequently, a second embodiment of the electronic device will be described with reference to FIGS. 8 to 10. The present embodiment will be described with a case in which the electronic device is applied to a portable computer 11 by way of example. The portable computer 11 is different from the first embodiment in the shape of a coupling part 33, but is common with the first embodiment in other parts. Therefore, the different parts from the first embodiment will be mainly described, and the common parts with the first embodiment will be omitted. The portable computer 11 according to the second embodiment has the same appearance as FIG. 1.

As illustrated in FIG. 8 and FIG. 9, a module 23 comprises a first attachment part 24 fixed to a display panel 21, for example, a second attachment part 25 connected to a printed circuit board 18 on a main body part 12 side, and a flexible printed circuit board 26 connecting the first attachment part 24 and the second attachment part 25. The first attachment part 24 is a so-called drive circuit for the display panel 21, and is housed inside a casing 22 together with the display panel 21. The second attachment part 25 is configured by traces or the like connected to the printed circuit board 18 of the main body part 12, and is arranged over both the main body part 12 and a display part 13.

As illustrated in FIG. 9, the flexible printed circuit board 26 comprises a first connection part 31 fixed to the first attachment part 24, a second connection part 32 fixed to the second attachment part 25, the coupling part 33 connecting the first connection part 31 and the second connection part 32, a plurality of bending parts provided in the middle of the coupling part 33, and a bonding sheet 27 provided on one side 32A of the second connection part 32.

The first connection part 31 is formed in a belt shape and linearly extends with a predetermined width. The first connection part 31 is fixed to the first attachment part 24 by ACF, for example. The first connection part 31 may be fixed thereto by soldering, ACP or the like. The second connection part 32 is formed in a belt shape and linearly extends with a predetermined width. The second connection part 32 extends substantially in parallel with the direction in which the first connection part 31 extends. The second connection part 32 is formed to be longer than the first connection part 31 in a second direction D2. The second connection part 32 is fixed to the second attachment part 25 by ACF, for example, but may be fixed thereto by soldering, ACP or the like similarly to the first connection part 31. The coupling part 33 has two separated parts 33A, and the two parts 33A configure a coupling part 33.

The coupling part 33 obliquely extends relative to a first direction D1 connecting the first connection part 31 and the second connection part 32. Specifically, the coupling part 33 is oblique away from the center of the first connection part 31 (or the second connection part 32) from the first connection part 31 toward the second connection part 32.

A slit 34 extending in the first direction D1 is provided between the two parts 33A of the coupling part 33. The slit 34 is provided in a substantially trapezoidal shape, and separates the two parts 33A of the coupling part 33. Each part 33A of the coupling part 33 is provided with two bending parts (a first bending part 41 and a second bending part 42). The bending part 41 provided near the first connection part 31 is bent in a valley shape, for example, as viewed from the other side 32B of the second connection part 32. The second bending part 42 provided near the second connection part 32 is bent in a mountain shape, for example, as viewed from the other side of the second connection part 32. Thus, as illustrated in FIG. 4 and others, the flexible printed circuit board 26 is bent substantially in a “Z” shape.

As illustrated in FIG. 8, the module 23 comprises a first region 43 where the bonding sheet 27 bonds the first attachment part 24 and the second connection part 32, a second region 44 where the bonding sheet 27 overlaps on the coupling part 33, a third region 45 where the bonding sheet 27 bonds the first connection part 31 and the second connection part 32, a first boundary part 46 between the first region 43 and the second region 44, and a second boundary part 47 between the second region 44 and the third region 45.

The operations of the folded module 23 according to the present embodiment will be described herein. Assuming a total repulsive force of the flexible printed circuit board 26 as W, a length of the first boundary part 46 and the second boundary part 47 as A/cos θ (FIG. 10), an anti-release strength of the bonding sheet 27 as B, the number of parts 33A contained in the coupling part 33 as n, and the number of bonding boundary parts between the flexible printed circuit board 26 and the bonding sheet 27 as 2n, the relationship B>(W/2n)/(A/cos θ) is met for the module 23 according to the present embodiment. That is, in the present embodiment, the coupling part 33 is provided with the slit 34, and thus the module 23 is formed with the third region 45 in correspondence to the slit 34 in addition to the first region 43 and the second region 44. Thus, the total repulsive force W acting in the release direction (the thickness direction of the bonding sheet 27) acts on not only the bonding sheet 27 in the first boundary part 46 but also the bonding sheet 27 in the second boundary part 47, and thus the repulsive force W acting on the bonding sheet 27 is dispersed in four portions.

In the present embodiment, the coupling part 33 is oblique, and thus the length of the first boundary part 46 and the second boundary part 47 can be greater than in the first embodiment. Thereby, the repulsive force W per unit area of the bonding sheet 27 adjacent to the first boundary part 46 and the second boundary part 47 is further reduced.

According to the second embodiment, the coupling part 33 obliquely extends relative to the first direction D1. The structure enables the length of the first boundary part 46 (a boundary part between the part 33A where the bonding sheet 27 bonds the second connection part 32 and the first attachment part 24 and the part where the bonding sheet 27 overlaps on the coupling part 33) and the second boundary part 47 (a boundary part between the part where the bonding sheet 27 bonds the second connection part 32 and the first connection part 31 inside the slit 34 and the part where the bonding sheet 27 overlaps on the coupling part 33) to be increased. Thereby, the repulsive force (force acting in the release direction) per unit area of the bonding sheet 27 along the first boundary part 46 and the second boundary part 47 can be further reduced than in the first embodiment. Thereby, the repulsive force of the flexible printed circuit board 26 does not focus on one portion, and the bonding sheet 27 is prevented from releasing.

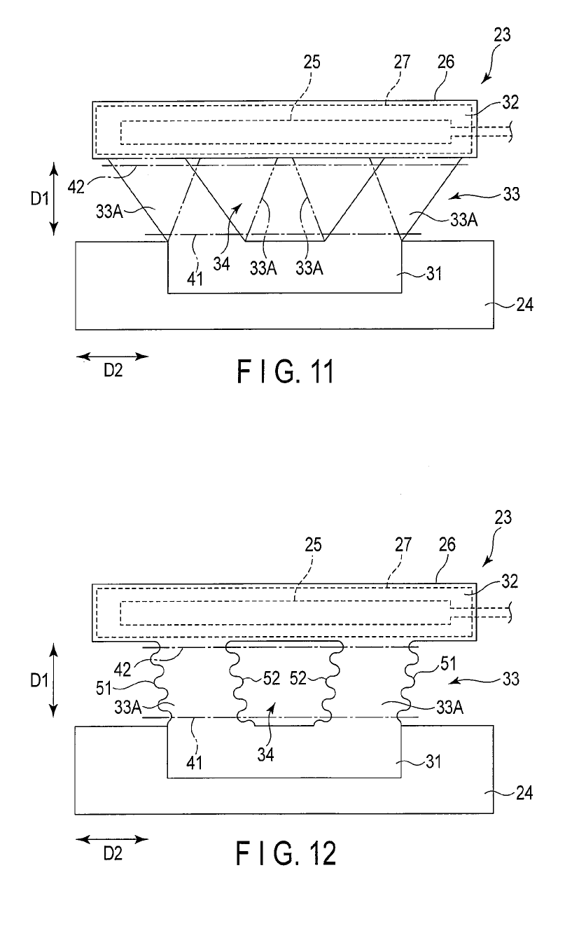

Variants of the second embodiment will be described with reference to FIG. 11.

In FIG. 11, the coupling part 33 of the flexible printed circuit board 26 according to a first variant is indicated in a solid line. According to the first variant, the coupling part 33 is oblique away from the center of the first connection part 31 (or the second connection part 32) from the first connection part 31 toward the second connection part 32 similarly to the second embodiment. In the first variant, however, the angle formed by the coupling part 33 relative to the first connection part 31 and the second connection part 32 is smaller than the angle formed by the coupling part 33 relative to the first connection part 31 and the second connection part 32 according to the second embodiment.

The present variant enables the first boundary part 46 (a boundary part between where the bonding sheet 27 bonds the second connection part 32 and the first attachment part 24 and where the bonding sheet 27 overlaps on the coupling part 33) and the second boundary part 47 (a boundary part between where the bonding sheet 27 bonds the second connection part 32 and the first connection part 31 inside the slit 34 and where the bonding sheet 27 overlaps on the coupling part 33) to be longer than in the first embodiment. Thereby, the repulsive force (force acting in the release direction) per unit area of the bonding sheet 27 along the first boundary part 46 and the second boundary part 47 can be further reduced than the first embodiment. Thereby, the bonding sheet 27 can be prevented from releasing.

In FIG. 11, the coupling part 33 of the flexible printed circuit board 26 according to a second variant is indicated in a dashed-two dotted line. In the second variant, the coupling part 33 is oblique toward the center of the flexible printed circuit board 26 (the first connection part 31, the second connection part 32) from the first connection part 31 toward the second connection part 32. The present variant also enables the length of the first boundary part 46 and the second boundary part 47 to be greater than in the first embodiment. Thereby, the repulsive force (force acting in the release direction) per unit area of the bonding sheet 27 along the first boundary part 46 and the second boundary part 47 can be further reduced than in the first embodiment. Thereby, the bonding sheet 27 can be prevented from releasing.

### Third Embodiment

Subsequently, a third embodiment of the electronic device will be described with reference to FIG. 12. The present embodiment will be described with a case in which the electronic device is applied to a portable computer 11 by way of example. The portable computer 11 is different from the second embodiment in the shape of a coupling part 33, and is common with the second embodiment in other parts. Therefore, the different parts from the second embodiment will be mainly described, and the common parts with the second embodiment will be omitted. The portable computer 11 according to the third embodiment has the same appearance as FIG. 1.

A module 23 comprises a first attachment part 24 fixed to a display panel 21, for example, a second attachment part 25 fixed to a printed circuit board 18 on a main body part 12 side, and a flexible printed circuit board 26 connecting the first attachment part 24 and the second attachment part 25. The first attachment part 24 is a so-called drive circuit for the display panel 21, and is housed inside a casing 22 together with the display panel 21. The second attachment part 25 is configured by traces or the like connected to the printed circuit board 18 of the main body part 12, and is arranged over both the main body part 12 and a display part 13.

The flexible printed circuit board 26 comprises a first connection part 31 fixed to the first attachment part 24, a second connection part 32 fixed to the second attachment part 25, the coupling part 33 connecting the first connection part 31 and the second connection part 32, a plurality of bending parts provided in the middle of the coupling part 33, and a bonding sheet 27 provided on one side 32A of the second connection part 32.

The first connection part 31 is formed in a belt shape and linearly extends with a predetermined width. The first connection part 31 is fixed to the first attachment part 24 by ACF, for example. The first connection part 31 may be fixed thereto by soldering, ACP or the like. The second connection part 32 is formed in a belt shape and linearly extends with a predetermined width. The second connection part 32 extends substantially in parallel with a direction in which the first connection part 31 extends. The second connection part 32 is formed to be longer than the first connection part 31 in a second direction D2. The second connection part 32 is fixed to the second attachment part 25 by ACF, for example, but may be fixed thereto by soldering, ACP or the like similarly to the first connection part 31. The coupling part 33 has two separated parts 33A, and the two parts 33A configure a coupling part 33.

The coupling part 33 obliquely extends relative to a first direction D1 connecting the first connection part 31 and the second connection part 32. Specifically, the coupling part 33 is oblique away from the center of the first connection part 31 (or the second connection part 32) from the first connection part 31 toward the second connection part 32.

A slit 34 extending in the first direction D1 is provided between the two parts 33A of the coupling part 33. The slit 34 is provided in a substantially trapezoidal shape, and separates the two parts 33A of the coupling part 33. Each part 33A of the coupling part 33 is provided with two bending parts (a first bending part 41 and a second bending part 42). The first bending part 41 provided near the first connection part 31 is bent in a valley shape, for example, as viewed from the other side 32B of the second connection part 32. The second bending part 42 provided near the second connection part 32 is bent in a mountain shape, for example, as viewed from the other side 32B of the second connection part 32. Thus, as illustrated in FIG. 4 and others, the flexible printed circuit board 26 is bent substantially in a “Z” shape on completion of assembly.

The coupling part 33 includes an outer edge part 51 defining the outer edge and an inner edge part 52 defining the slit 34. Both the outer edge part 51 and the inner edge part 52 are corrugated. The outer edge part 51 is provided farther away from the center of the flexible printed circuit board 26 (the first connection part 31, the second connection part 32) than the inner edge part 52. The outer edge part 51 defines a periphery not continuous with the first connection part 31 or the second connection part 32 in the coupling part 33.

As illustrated in FIG. 8, the module 23 comprises a first region 43 where the bonding sheet 27 bonds the first attachment part 24 and the second connection part 32, a second region 44 where the bonding sheet 27 overlaps on the coupling part 33, a third region 45 where the bonding sheet 27 bonds the first connection part 31 and the second connection part 32, a first boundary part 46 between the first region 43 and the second region 44, and a second boundary part 47 between the second region 44 and the third region 45.

The operations of the folded module 23 according to the present embodiment will be described herein. In the present embodiment, the coupling part 33 is provided with the slit 34, and thus the module 23 is formed with the third region 45 in correspondence to the slit 34 in addition to the first region 43 and the second region 44. Thus, the total repulsive force acting in the release direction (the thickness direction of the bonding sheet 27) acts on not only the bonding sheet 27 in the first boundary part 46 but also the bonding sheet 27 in the second boundary part 47, and thus the repulsive force W acting on the bonding sheet 27 is dispersed in four portions.

In the present embodiment, the coupling part 33 is oblique, and thus the length of the first boundary part 46 and the second boundary part 47 can be made longer than in the first embodiment. In the present embodiment, the inner edge part 52 and the outer edge part 51 of the coupling part 33 are corrugated, and thus the length of the first boundary part 46 and the second boundary part 47 can be further increased. Thereby, the repulsive force W per unit area of the bonding sheet 27 adjacent to the first boundary part 46 and the second boundary part 47 can be further reduced.

According to the third embodiment, the coupling part 33 includes the outer edge part 51 defining the outer edge and the outer edge part 51 is corrugated. The coupling part 33 includes the inner edge part 52 defining the slit 34 and the inner edge part 52 is corrugated. The structure enables the length of the first boundary part 46 and the second boundary part 47 to be greater than in the second embodiment. Thereby, the repulsive force (force acting in the release direction) per unit area of the bonding sheet 27 along the first boundary part 46 and the second boundary part 47 can be further reduced. Thus, the repulsive force of the flexible printed circuit board 26 does not focus on one portion, and the bonding sheet 27 can be further prevented from releasing.

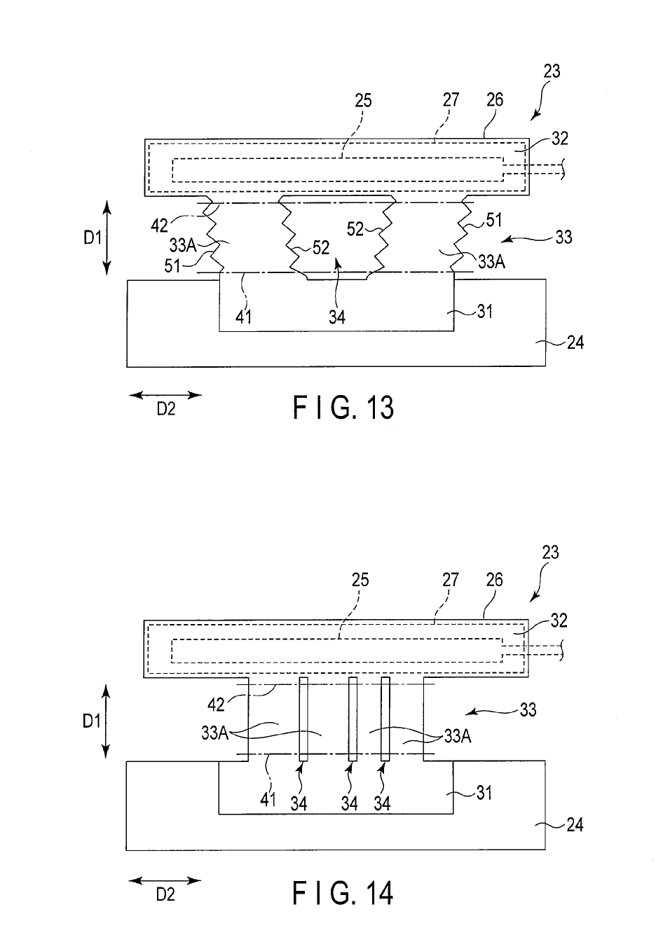

A variant (third variant) of the third embodiment will be described with reference to FIG. 13.

In the third variant, the coupling part 33 is oblique farther away from the center of the first connection part 31 (or the second connection part 32) from the first connection part 31 toward the second connection part 32 similarly to the third embodiment. In the present variant, however, both the outer edge part 51 and the inner edge part 52 of the coupling part 33 have a zigzag shape.

The present variant enables the length of the first boundary part 46 and the second boundary part 47 to be greater than in the second embodiment. Thereby, the repulsive force (force acting in the release direction) per unit area of the bonding sheet 27 along the first boundary part 46 and the second boundary part 47 can be further reduced than in the second embodiment. Thereby, the bonding sheet 27 can be prevented from releasing.

### Fourth Embodiment

Subsequently, a fourth embodiment of the electronic device will be described with reference to FIG. 14. The present embodiment will be described with a case in which the electronic device is applied to a portable computer 11 by way of example. The portable computer 11 is different from the first embodiment in the number of parts configuring a coupling part 33 and the number of slits 34, but is common with the first embodiment in other parts. Therefore, the different parts from the first embodiment will be mainly described, and the common parts with the first embodiment will be omitted. The portable computer 11 according to the fourth embodiment has the same appearance as FIG. 1.

A module 23 comprises a first attachment part 24 fixed to a display panel 21, for example, a second attachment part 25 connected to a printed circuit board 18 on a main body part 12 side, and a flexible printed circuit board 26 connecting the first attachment part 24 and the second attachment part 25. The first attachment part 24 is a so-called drive circuit for the display panel 21, and is housed inside the casing 22 together with the display panel 21. The second attachment part 25 is configured by traces or the like connected to the printed circuit board 18 of the main body part 12, and is arranged over both the main body part 12 and a display part 13.

The flexible printed circuit board 26 comprises a first connection part 31 fixed to the first attachment part 24, a second connection part 32 fixed to the second attachment part 25, the coupling part 33 connecting the first connection part 31 and the second connection part 32, a plurality of bending parts provided in the middle of the coupling part 33, and a bonding sheet 27 provided on one side 32A of the second connection part 32.

The first connection part 31 has a predetermined width and extends in a belt shape. The first connection part 31 is fixed to the first attachment part 24 by ACF, for example. The first connection part 31 may be fixed thereto by soldering, ACP or the like. The second connection part 32 is formed in a belt shape with a predetermined width, and extends substantially in parallel with a direction in which the first connection part 31 extends. The second connection part 32 is formed to be longer than the first connection part in a second direction D2. The second connection part 32 is fixed to the second attachment part 25 by ACF, for example, but may be fixed thereto by soldering, ACP or the like similarly to the first connection part 31. The coupling part 33 has four mutually-separated parts 33A, and the four parts 33A configure a coupling part 33.

The lengths (widths) of each part 33A of the coupling part 33 in the second direction D2 are mutually different.

A plurality (such as three) of slits 34 extending in a first direction D1 are provided between the parts 33A of the coupling part 33. Each slit 34 is provided in a substantially square shape, and separates two adjacent parts 33A of the coupling part 33. Each part 33A of the coupling part 33 is provided with two bending parts (a first bending part 41 and a second bending part 42).

The first bending part 41 provided near the first connection part 31 is bent in a valley shape, for example, as viewed from the other side 32B of the second connection part 32. The second bending part 42 provided near the second connection part 32 is bent in a mountain shape, for example, as viewed from the other side of the second connection part 32. Thus, as illustrated in FIG. 4 and others, the flexible printed circuit board 26 is bent substantially in a “Z” shape.

The module 23 comprises a first region 43 where the bonding sheet 27 bonds the first attachment part 24 and the second connection part 32, a second region 44 where the bonding sheet 27 overlaps on the coupling part 33, a third region 45 where the bonding sheet 27 bonds the first connection part 31 and the second connection part 32, a first boundary part 46 between the first region 43 and the second region 44, and a second boundary part 47 between the second region 44 and the third region 45.

The operations of the folded module 23 according to the present embodiment will be described herein. Assuming a total repulsive force of the flexible printed circuit board 26 as W, a width of the bonding sheet 27 in the first direction D1 as A, an anti-release strength of the bonding sheet 27 as B, the number of parts 33A contained in the coupling part 33 as n, and the number of bonding boundary parts between the flexible printed circuit board 26 and the bonding sheet 27 as 2n, the relationship B>(W/2n)/A is met for the module 23 according to the present embodiment. That is, according to the present embodiment, the coupling part 33 is provided with the slits 34, and thus the module 23 is formed with the third regions 45 in correspondence to the slits 34 in addition to the first region 43 and the second region 44. Thus, the total repulsive force W acting in the release direction (the thickness direction of the bonding sheet 27) acts on not only the bonding sheet along the first boundary part 46 but also the bonding sheet 27 along the second boundary part 47. Thus, the repulsive force W acting on the bonding sheet 27 is dispersed in a plurality of portions (eight portions), and the bonding sheet 27 is prevented from releasing.

According to the fourth embodiment, the number of slits 34 is increased, and correspondingly the repulsive force (force acting in the release direction) per unit area of the bonding sheet 27 along the first boundary part 46 and the second boundary part 47 can be further reduced than in the first embodiment. Thereby, the repulsive force of the flexible printed circuit board 26 does not focus on one portion, and the bonding sheet 27 can be prevented from releasing.

The electronic device is not limited to the portable computer 11 described in the above embodiments, and is naturally applicable to other electronic devices such as TV, cell phone, tablet device, Smartphone, and electronic book reader configured to electronically display books and images.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising: a first attachment part; a second attachment part provided by separation from the first attachment part; a flexible printed circuit board having a first connection part fixed to the first attachment part, a second connection part fixed to the second attachment part, a coupling part configured to couple the first connection part and the second connection part and provided with a slit extending in a first direction connecting the first connection part and the second connection part, and a bending part provided in the middle of the coupling part; and a bonding sheet provided on one side of the second connection part and configured to bond the second connection part and the first attachment part away from the coupling part in a second direction along a direction in which the second connection part extends, and to bond the second connection part and the first connection part inside the slit.

2. The electronic device according to claim 1, wherein the coupling part obliquely extends relative to the first direction.

3. The electronic device according to claim 1, wherein the coupling part includes an outer edge part defining an outer edge, and the outer edge part is corrugated.

4. The electronic device according to claim 1, wherein the coupling part includes an inner edge part defining the slit, and the inner edge part is corrugated.

5. The electronic device according to claim 1, wherein the coupling part includes an outer edge part defining an outer edge, and the outer edge part has a zigzag shape.

6. The electronic device according to claim 1, wherein the coupling part includes an inner edge part defining the slit, and the inner edge part has a zigzag shape.

7. The electronic device according to claim 1, wherein the first attachment part is a drive circuit for a display panel.

8. The electronic device according to claim 1, wherein the second attachment part is traces connected to a main body part.

9. A module comprising: a first attachment part; a second attachment part provided by separation from the first attachment part; a flexible printed circuit board having a first connection part fixed to the first attachment part, a second connection part fixed to the second attachment part, a coupling part configured to couple the first connection part and the second connection part and provided with a slit extending in a first direction connecting the first connection part and the second connection part, and a bending part provided in the middle of the coupling part; and a bonding sheet provided on one side of the second connection part, and configured to bond the second connection part and the first attachment part away from the coupling part in a second direction along a direction in which the second connection part extends, and to bond the second connection part and the first connection part inside the slit.
